(19) United States
(12) Patent Application Publication
(10) Pub. No.: US 2014/0264150 A1
(43) Pub. Date: Sep. 18, 2014

(54) Glycerol Engine Coolant Systems

(71) Applicant: GLOBALTECH FLUIDS, LLC, ORLANDO, FL (US)

(72) Inventor: Oscar Domingo, ORLANDO, FL (US)

(73) Assignee: GLOBALTECH FLUIDS, LLC, ORLANDO, FL (US)

(21) Appl. No.: 14/207,349

(22) Filed: Mar. 12, 2014

Related U.S. Application Data
(60) Provisional application No. 61/896,437, filed on Oct. 28, 2013.
(60) Provisional application No. 61/889,341, filed on Oct. 10, 2013.
(60) Provisional application No. 61/824,641, filed on May 17, 2013.
(60) Provisional application No. 61/780,016, filed on Mar. 13, 2013.

(51) Int. Cl. C09K 5/20

(52) U.S. Cl. CPC C09K 5/20
USPC 252/73

(57) ABSTRACT

A system for modifying retained co-products of biodiesel production to provide usable and inexpensive anti-freeze coolant products. A low-toxicity anti-freeze composition is also disclosed.

### CROSS-REFERENCE TO RELATED APPLICATION

The present application is related to and claims priority from prior provisional application Ser. No. 61/896,437, filed Oct. 28, 2013, entitled “GLYCERIN ENGINE COOLANT SYSTEMS”; and, the present application is related to and claims priority from prior provisional application Ser. No. 61/889,341, filed Oct. 10, 2013, entitled “GLYCERIN ENGINE COOLANT SYSTEMS”; and, the present application is related to and claims priority from prior provisional application Ser. No. 61/824,641, filed May 17, 2013, entitled “GLYCERIN COOLANT SYSTEMS”; and, the present application is related to and claims priority from prior provisional application Ser. No. 61/780,016, filed Mar. 13, 2013, entitled “GLYCERIN COOLANT SYSTEMS”, the entire contents of each of which applications are incorporated herein by this reference for any purpose in their entirety.

### BACKGROUND

This invention relates to a system for producing useful engine-coolant compositions making use of by-products of biodiesel production. More particularly, this invention relates to providing an anti-freeze coolant base material retained from a waste material from biodiesel manufacture. More particularly, this invention relates to methods of producing engine-coolant liquids from such a retained base material containing primarily glycerol, methanol, and water derived and retained from biodiesel production.

A known process for the production of biodiesel involves the transesterification of triglycerides contained in vegetable oils or animal fat, using a short-chain alcohol in the presence of an alkaline catalyst. During such transesterification process, the triglycerides are broken down to generate fatty acids and propane-1,2,3-triol (also referred to herein as glycerol). The fatty acids react with the alcohol (usually methanol, sometimes ethanol) to form a mono-alkyl ester (also referred to herein as biodiesel). Because the reaction of fatty acids to form mono-alkyl ester is reversible, excess amounts of the alcohol reactant are generally used to shift reaction equilibrium in favor of mono-alkyl ester production. Therefore, significant amounts of un-reacted alcohol remain at the end of production.

Due to differences in density between glycerol and mono-alkyl ester, the two are easily separated after they are created by the transesterification of the triglycerides. Since the primary economic value presently resides in the biodiesel, the biodiesel component is extracted leaving the remaining glycerol, water, salts, and un-reacted alcohol as a by-product of the biodiesel production (this remaining material is sometimes herein called “crude glycerol”).

Historically, recovery of the crude glycerol has been limited to anaerobic digestion, for example to create bio-gas, or by transporting the waste glycerol to a refinery for distillation; however, eighty percent glycerol purity is typically required to sell to glycerol refineries. Furthermore, purification of crude glycerol by such distillation is expensive, requiring large amounts of energy to accomplish.

The efficient secondary utilization of waste materials is a key concept in the environmentally responsible production of goods and materials. Development of an economically-viable secondary use for the waste products of biodiesel production, particularly those requiring minimal expenditures of post-processing energy resources, would be of great benefit to many.

### OBJECTS AND FEATURES OF THE INVENTION

A primary object and feature of the present invention is to provide a system addressing the above-mentioned need.

It is a further object and feature of the present invention to provide a method of manufacturing an engine anti-freeze coolant which consists primarily of the waste product of biodiesel production. It is a further object and feature of the present invention to provide a non-toxic anti-freeze coolant for use in engines.

It is a further object and feature of the present invention to provide such an anti-freeze coolant that uses glycerol retained from a waste material from biodiesel manufacture. It is a further object and feature of the present invention to provide such an anti-freeze coolant that uses methanol retained from a waste material from biodiesel manufacture. It is a further object and feature of the present invention to provide such an anti-freeze coolant that uses water retained from a waste material from biodiesel manufacture. It is a further object and feature of the present invention to provide such an anti-freeze coolant that uses a mixture of glycerol, methanol, and water retained from a waste material from biodiesel manufacture. It is a further object and feature of the present invention to provide an anti-freeze base material produced by modifying the waste materials from biodiesel production so that the resulting waste material contains no substantial amount of any of the waste material ingredients other than the retained glycerol, retained alcohol (preferably methanol), and retained water.

It is a further object and feature of the present invention to provide such an anti-freeze base material by removing salts from waste material from biodiesel manufacture. It is a further object and feature of the present invention to provide such an anti-freeze base material by removing salts from waste material from biodiesel manufacture using electrodialysis. It is a further object and feature of the present invention to provide such an anti-freeze base material by removing salts from waste material from biodiesel manufacture using ion exchange chromatography. It is a further object and feature of the present invention to provide such an anti-freeze base material by removing salts from waste material from biodiesel manufacture using nanofiltration systems. It is a further object and feature of the present invention to provide such an anti-freeze base material by removing salts from waste material from biodiesel manufacture using reverse osmosis filters.

It is a further object and feature of the present invention to provide such an anti-freeze coolant that includes at least one corrosion inhibitor.

It is a further object and feature of the present invention to provide such an anti-freeze coolant that has a freezing point below −50° C. (−58° F.), preferably below −30° C. (−22° F.).

It is a further object and feature of the present invention to provide a system to mix added water with such an anti-freeze base material, at a mix location abutting the location of use of such mixture. It is a further object and feature of the present invention to provide a system to mix the at least one corrosion inhibitor with such an anti-freeze base material at the time of use so as to meet a customer's changing needs.

It is another object and feature of the present invention to provide a low-toxicity anti-freeze composition that is safer if ingested.

A further primary object and feature of the present invention is to provide such a system that is efficient, inexpensive, and useful. Other objects and features of this invention will become apparent with reference to the following descriptions.

### SUMMARY OF THE INVENTION

In accordance with a preferred embodiment hereof, this invention provides an anti-freeze coolant base, retained from a co-product “waste material” from biodiesel manufacture, comprising: retained glycerol from the waste material from biodiesel manufacture; retained methanol from the waste material from biodiesel manufacture; and retained water from the waste material from biodiesel manufacture; wherein such anti-freeze coolant base contains no substantial amount of any retained waste material ingredients other than glycerol, methanol, and water. Moreover, it provides such an anti-freeze coolant base wherein the ratio (by weight) of retained glycerol to retained methanol is in the range of from about 2½ to 1 to about 7 to 1.

Additionally, it provides such an anti-freeze coolant base further comprising an added amount of water not from retained waste material. Also, it provides such an anti-freeze coolant base further comprising an added amount of water not from retained waste material. In addition, it provides such an anti-freeze coolant base further comprising an added amount of methanol not from retained waste material.

In accordance with another preferred embodiment hereof, this invention provides an anti-freeze coolant base, retained from a co-product “waste material” from biodiesel manufacture, comprising: retained glycerol from the waste material from biodiesel manufacture; retained alcohol from the waste material from biodiesel manufacture; and retained water from the waste material from biodiesel manufacture; wherein such anti-freeze coolant base contains no substantial amount of any retained waste material ingredients other than glycerol, alcohol, and water. And, it provides such an anti-freeze coolant base wherein the ratio (by weight) of retained glycerol to retained alcohol is in the range of from about 2½ to 1 to about 7 to 1.

Further, it provides such an anti-freeze coolant base further comprising an added amount of water not from retained waste material. Even further, it provides such an anti-freeze coolant base further comprising an added amount of water not from retained waste material. Moreover, it provides such an anti-freeze coolant base further comprising an added amount of alcohol not from retained waste material. Additionally, it provides such an anti-freeze coolant base, according to the above-noted preferred features, further comprising at least one effective corrosion inhibitor(s) in effective amounts for at least one projected use.

In accordance with another preferred embodiment hereof, this invention provides a method of manufacture, of an anti-freeze coolant, comprising the steps of: identifying a biodiesel manufacturer; identifying a manner of disposal by the biodiesel manufacturer of a crude glycerol co-product “waste material” from biodiesel manufacture; arranging to possess and move the waste material to an anti-freeze coolant manufacturer; modifying the waste material to provide an anti-freeze coolant base comprising retained glycerol from the waste material from biodiesel manufacture; retained alcohol from the waste material from biodiesel manufacture; and retained water from the waste material from biodiesel manufacture; wherein the anti-freeze coolant base contains no substantial amount of any retained waste material ingredients other than glycerol, alcohol, and water. Also, it provides such a method of manufacture wherein the step of modifying the waste material to provide an anti-freeze coolant base comprises the step of: removing retained salts from the waste material from biodiesel manufacture; wherein the anti-freeze coolant base becomes an onsite-ready anti-freeze coolant base.

In addition, it provides such a method of manufacture wherein the step of removing retained salts from the waste material from biodiesel manufacture comprises the step of: at least one passing of the waste material through a user-selected membrane. And, it provides such a method of manufacture further comprising the step of: onsite mixing of the onsite-ready anti-freeze coolant base with added ingredients to provide a user-selected anti-freeze coolant composition. Further, it provides such a method of manufacture wherein the step of onsite mixing comprises the step of computer-assisting at least one control system to sense and control flows and mixtures to provide the user-selected anti-freeze coolant composition. Even further, it provides such a method of manufacture, according to the above-noted preferred steps wherein the alcohol comprises methanol.

Moreover, it provides such a method of manufacture wherein the alcohol comprises methanol. Additionally, it provides such a method of manufacture wherein such user-selected anti-freeze coolant composition comprises an added amount of ethanol. Additionally, it provides such a method of manufacture wherein such user-selected anti-freeze coolant composition comprises from about 1% to about 5% ethanol by volume. Also, it provides such a method of manufacture wherein such user-selected anti-freeze coolant composition comprises between about 0.01% and 20% ethanol by volume.

In accordance with another preferred embodiment hereof, this invention provides a low-toxicity anti-freeze coolant composition, having at least one component retained from a co-product “waste material” of biodiesel manufacture, such low-toxicity anti-freeze coolant composition comprising: retained glycerol from the waste material from biodiesel manufacture; retained methanol from the waste material from biodiesel manufacture; retained water from the waste material from biodiesel manufacture; and ethanol; wherein the amount of such ethanol is between about 0.01% and about 20% by volume. In addition, it provides such a low-toxicity anti-freeze coolant composition wherein the amount of such ethanol is between about 1% and 5% ethanol by volume. And, it provides such a low-toxicity anti-freeze coolant composition wherein the ratio of such ethanol to such retained methanol is about 1:4 by volume. Further, it provides such a low-toxicity anti-freeze coolant composition further comprising ethylene glycol. Even further, it provides such a low-toxicity anti-freeze coolant composition further comprising at least one effective corrosion inhibitor(s) in effective amounts for at least one projected use.

In accordance with another preferred embodiment hereof, this invention provides a method of making a low toxicity anti-freeze coolant base composition, such method comprising the steps of: specifying at least one first non-ethanol composition consisting of at least one non-ethanol user-selected alcohol; specifying at least one second composition consisting of ethanol; controlling the relative amounts of the at least one first non-ethanol composition, the at least one second composition, and water to provide at least one user-selected anti-freeze coolant base composition to use in a specified closed thermal control device; and adding the at least one user-selected anti-freeze coolant base composition into the specified closed thermal control device; wherein the percentage by volume, in the at least one user-selected anti-freeze coolant base composition, of ethanol to the at least one user-selected anti-freeze coolant base composition is between about 0.01% and about 20% of ethanol. Moreover, it provides such a method of wherein the percentage by volume, in the at least one user-selected anti-freeze coolant base composition, of ethanol to the at least one user-selected anti-freeze coolant base composition is between about 1% and 5% of ethanol. Additionally, it provides such a method wherein the percentage by volume, in the at least one user-selected anti-freeze coolant base composition, of ethanol to the at least one user-selected anti-freeze coolant base composition is about 2% of ethanol.

In accordance with another preferred embodiment hereof, this invention provides a method of making a low toxicity anti-freeze coolant base composition, such method comprising the steps of: specifying at least one first composition selected from the group consisting of at least one non-ethanol user-selected alcohol at least one alcohol precursor having a property to become the at least one non-ethanol user-selected alcohol when mixed with water; specifying at least one second composition selected from the group consisting of ethanol at least one ethanol precursor having a property to become ethanol when mixed with water; controlling the relative amounts of the at least one first composition, the at least one second composition, and water to provide at least one user-selected anti-freeze coolant base composition to use in a specified closed thermal control device; and adding the at least one user-selected anti-freeze coolant base composition into the specified closed thermal control device; wherein the percentage by volume, in the at least one user-selected anti-freeze coolant base composition, of ethanol to the at least one user-selected anti-freeze coolant base composition is between about 0.01% and about 20% of ethanol. Moreover, it provides such a method of wherein the percentage by volume, in the at least one user-selected anti-freeze coolant base composition, of ethanol to the at least one user-selected anti-freeze coolant base composition is between about 1% and 5% of ethanol. Additionally, it provides such a method wherein the percentage by volume, in the at least one user-selected anti-freeze coolant base composition, of ethanol to the at least one user-selected anti-freeze coolant base composition is about 2% of ethanol. In accordance with preferred embodiments hereof, this invention provides each and every novel feature, element, combination, step and/or method disclosed or suggested by this patent application.

### BRIEF DESCRIPTION OF THE DRAWINGS

FIG. 1 shows a schematic flow diagram, illustrating steps in the implementation of manufacture of an anti-freeze coolant, for use in engines, according to a preferred embodiment of the present invention.

FIG. 2 shows a diagram, illustrating triglycerides reacting with a primary alcohol to form methyl esters of fatty acids and glycerol.

FIG. 3 shows a ternary diagram, illustrating four example data points and five freezing point curves.

FIG. 4 shows a representation of how anti-freeze base material is shipped from the anti-freeze manufacture and then used by the engine manufacture.

FIG. 5 shows a schematic diagram of a mixing system for the onsite preparation of anti-freeze coolant (from anti-freeze base material) to be installed within a vehicle assembly site.

FIG. 6 shows a flow diagram depicting steps in a process of making a low toxicity anti-freeze coolant base composition, according to a preferred method of the present invention.

### DETAILED DESCRIPTION OF THE BEST MODES AND PREFERRED EMBODIMENTS OF THE INVENTION

The present invention, identified herein as glycerol engine-coolant system 100, generally relates to applicant's preferred methods of producing engine coolants derived primarily from the by-product of biodiesel production. Applicant arrived at the present invention while performing experimentation into alternate formulations of engine-coolants that are principally focused on glycerol mixtures containing a primary alcohol and water. During such experimentation, applicant found that workable ingredient proportions among the glycerol and primary alcohol are also proportions present in the components of the co-product fluid from biodiesel manufacture.

Applicant has further found that preferred blendings, using the glycerol/alcohol proportions of this co-product “waste” material, provide an excellent replacement for propylene glycol (PG) and a good replacement for ethylene glycol (EG) for use in engine coolants. These preferred blendings provide low-toxicity coolants and the cost of the raw material may be insignificantly low where such co-product is treated as a waste product.

Applicant's research and laboratory experimentation with different such preferred blendings of glycerol, methanol, and water, and adding corrosion-inhibitor products, supported applicant's idea of using this by-product of biodiesel production as an intermediate system/step to low-cost glycerol-based engine antifreezes/coolants.

Thus, processing this co-product fluid to retain these three ingredients, while removing other impurity ingredients, provides a preferred base fluid to lower the cost of glycerol-based engine coolant enough to provide an alternative to glycols.

Applicant, as herein stated, also found that the relative amounts of glycerol and methanol suitable for the coolant were similar to the relative amounts in the “waste” co-product from the bio-diesel manufacture. Thus, a preferred aspect of applicant's invention is to purify this co-product by removing unwanted constituents, other than the three above-identified primary ingredients, for example, removing residual fatty acids and salts and unwanted particulates and then modifying the “retained” blended base material to add and/or adjust ingredients to reach the exact proportions specified for each coolant customer.

Applicant has also found that the mixing of glycerol with methanol lends the mixture better “anti-freeze/coolant” properties than either ingredient used alone, e.g., the mixture has less viscosity than glycerin alone and the mixture has less volatility than methanol used alone.

Also, this preferred utilization of the by-products of biodiesel production potentially resolves the significant problem of waste disposal within the biodiesel manufacturing industry, even while providing a low-cost and low-toxicity antifreeze alternative.

The following section presents a general overview of biodiesel production and is provided as general information supporting the subsequent disclosure of key aspects of glycerol engine coolant system 100. Referring to the drawings, FIG. 1 shows a schematic flow diagram, illustrating an overview of preferred steps and principal materials used in the implementation of the manufacture of glycerol-based anti-freeze coolant 107, for use with engines, according to preferred embodiments of the present invention. FIG. 2 is a chemical-reaction diagram illustrating a representative transesterification process wherein triglycerides 101 react with methanol 102 to form methyl esters of fatty acids 103 and glycerol 104.

In the diagram of FIG. 1, production of biodiesel 304 is preferably implemented by biodiesel manufacturer 302 using, as one preferred example, the transesterification process generally depicted in the chemical-reaction diagram of FIG. 2. During such transesterification process, triglycerides preferably are broken down to generate fatty acids 103 and glycerol 104. Fatty acids 103 preferably react with methanol 102, or alternately preferably ethanol, to form biodiesel 304. The reaction between alcohols and fatty acids to form biodiesel 304 is a reversible reaction. Since this reaction is reversible, it is usual for biodiesel manufacturer 302 to introduce an excess amount of methanol 102 (or ethanol) to shift the reaction equilibrium in favor of biodiesel production. The result is the presence of significant amounts of un-reacted methanol 102 remaining at the completion of the principal reaction.

Due to differences in density between glycerol and the mono-alkyl ester forming biodiesel 304, the two compounds are readily separated after they are created. Since the primary economic value resides in biodiesel 304, the biodiesel component is extracted, leaving behind glycerol, water, salts, and un-reacted alcohol as a by-product of the synthesis. For clarity of description, this waste by-product will be referred to as crude glycerol 104.

Production of biodiesel can result in approximately 10 percent production of crude glycerol 104. The crude “waste” is generally about 50 to 70 percent by weight (wt %) glycerol 104. The remaining components consist of about 10 to 20 wt % methanol, less than about 1 to 5 wt % water, less than about 1 to 10 wt % free fatty acids, less than about 1 to 10 wt % MONG (monoglycerides, diglycerides, triglycerides, methyl ester, and other organics), generally with a pH in the range of between about 11 to about 14.

Furthermore, crude glycerol 104 frequently includes about five to seven percent salts. These salts appear as a result of using alkaline transesterification catalysts during synthesis, such as sodium methylate. As an example, sodium chloride forms when sodium methylate is neutralized with hydrochloric acid. Other contamination can include food particles, meat, bone, breading (when the waste oil from restaurants is used for biodiesel production), etc.

Apart from the glycerol, methanol, and water, it is preferred that concentrations of the other above-noted constituents of the crude glycerol 104 be reduced or eliminated prior to use as the base fluid engine coolant. Thus, anti-freeze coolant manufacturer 308 of glycerol engine-coolant system 100 preferably implements at least one glycerol refinement process 350. Depending on end-use performance requirements of the finished anti-freeze coolant 107, such glycerol refinement process 350 may preferably comprise simple filtering of contaminating particulates, membrane-based salt reduction, or more complex refinement processes. As a result of removing other impurities to provide only retained glycerol, retained methanol, and retained water (with no substantial amount of other ingredients), applicant preferably thereby provides a base for glycerol-based engine coolant (anti-freeze base material 310) as, for example, a lower-cost alternative to glycol-based engine coolants, especially useful for engines projected for use in temperate climates where antifreeze protection to −20F to −30F is sufficient.

Generally, it is preferred that only critical contaminants be removed from the crude glycerol 104. For example, it is preferred that at least visible particulates and excess salts be removed from the crude glycerol 104. It is noted that separation of the methanol and water preferably is not necessary as they are preferred components of any subsequently-produced glycerol-based anti-freeze coolant 107.

More preferably, such crude glycerol refinement process 350 comprises measures to reduce or eliminate any contaminates that do not consist of glycerol, methanol, or water constituents, most notably salts. Most preferably, glycerol refinement process 350 comprises a commercially available glycerol refinement process, which can be adapted to substantially retain at least preferably the methanol constituent and preferably the water constituent of crude glycerol 104. Such commercial systems have been produced using specially-selected membranes, reverse osmosis, and ion-exchange chromatography, and as generally described below.

As a preferred example of implementation of glycerol refinement process 350, the EET Corporation of Harriman, Tenn. has developed a commercial product for refinement of glycerol 104 based in traditional electrodialysis desalting methods. The preferred EET Corporation method uses high-efficiency electrodialysis to purify glycerol 104 with ion exchange and membranes, where feed temperatures are up to 35° C. (95° F.).

As another preferred example of implementation of glycerol refinement process 350 (but complicated by the preference to recapture methanol fumes), the Dow Chemical Company subsidiary Rohm and Haas has developed a preferred system, which is currently marketed to biodiesel producers under the trade name “AMBERSEP™ BD50”. The AMBERSEP™ BD50 system can purify glycerol 104 to ninety-nine percent, or if using a polishing step, up to five parts per million salt content. The AMBERSEP™ BD50 heats crude glycerol 104 to 90° C. (194° F.), then filters, and degases crude glycerol 104. Then crude glycerol 104 undergoes chromatographic separation on separation resin with sequential simulated moving bed technology. The system is preferably modified to retain or recapture the methanol, which comprises a relatively lower boiling point of 64.7° C. (148° F.).

While glycerol has the advantage of low toxicity, glycerol is disadvantaged as an anti-freeze component by a higher freezing point, when compared to the customarily used ethylene glycol. Furthermore, glycerol has a relatively high viscosity, which generally correlates with reduced heat-transfer characteristics. The high viscosity of glycerol also creates difficulties with manipulation of the material during its use. Another disadvantage of glycerol is that it can creep rapidly through seals and crevices that would be barriers to methanol 102 or ethanol. For these reasons, as well as cost considerations, there has been little motivation to substitute the predominantly-used ethylene glycol with glycerol. Thus, the use of glycerol alone as a contemporary engine coolant is not an intuitive choice, due to its relatively higher freezing point and liquid viscosity.

Applicant has performed experimentation focused on glycerol mixtures containing methanol and water (as found in crude glycerol 104). Applicant has found that a preferred blending of glycerol with methanol, water, and a corrosion inhibitor unexpectedly produced a useful engine anti-freeze coolant for operation within a temperature range most frequently expected during vehicle operation in temperate regions. Applicant's optimal preferred mixture of these components appears, from applicant's research and empirical testing, to remove some of the previously known limitations associated with using glycerol as an engine coolant. Thus, applicant anticipates that applicant's glycerol-based anti-freeze coolant 107 will be readily adopted as an excellent replacement for propylene glycol and, alternately preferably, a good replacement for ethylene glycol based engine coolants. It is again noted that preferred blendings of these components may provide a coolant of low human and animal toxicity.

Applicant has also found that the mixing of glycerol with methanol lends the mixture better “anti-freeze/coolant” properties than either component used alone, e.g., the mixture has less viscosity than glycerol alone and the mixture has less volatility than methanol used alone. Using a preferred mixture of glycerol, methanol, water and at least one corrosion-inhibiting additive preferably results in a low-cost coolant with properties similar to propylene-glycol-based coolants. For example, Applicant has worked with different-mixture ratios of glycerol, methanol, water, and applicant's corrosion-inhibiting additive (marketed under the trade name “GTC-580”) to determine freezing-point data.

FIG. 3 shows a three-axis ternary diagram, illustrating a set of experimentally-derived freezing point curves. These freezing point curves are identified herein as freezing point curve 202 at −10° C. (14° F.), freezing point curve 204 at −20° C. (−4° F.), freezing point curve 206 at −30° C. (−22° F.), freezing point curve 208 at −40° C. (−40° F.), and freezing point curve 210 at −50° C. (−58° F.). It is noted that the depicted set of freezing point curves are based on measured freezing point depressions (based on combining pure ingredients) published in the article entitled “Freezing Points of the Ternary System Glycerol-Methanol-Water”, 1936, Feldman, Harry B., Dahlstrom, Walter G., Industrial & Engineering Chemistry 28 (11), pp 1316-1317.

Referring to FIG. 3, the end points of freezing point curve 208 at −40° C. (−40° F.) indicates freezing points of as low as −40° C. (−40° F.) can be achieved. The end points correspond to ratios of 60 percent water to 0 percent glycerol to 40 percent methanol by weight at one end, and on the other end point of the curve 17.5 percent water to 62.5 percent glycerol to 0 percent methanol by weight.

The end points of freezing point curve 210 at −50° C. (−58° F.) indicates freezing points as low as −50° C. (−58° F.) can be achieved. The end points correspond to ratios of 52.5 percent water to 0 percent glycerol to 47.7 percent methanol by weight at one end, and on the other end point of the curve 12.5 percent water to 67.5 percent glycerol to 0 percent methanol by weight.

FIG. 3 further illustrates example data point A, example data point B, example data point C, and example data point D. These preferred example data points were plotted onto the graph to determine approximate freezing point ranges expected from these preferred example mixtures. Example data point A corresponds to a preferred mixture with the ratios of about 58 percent glycerol to about 8 percent methanol to about 33 percent water by weight. Example data point B corresponds to a preferred mixture with the ratios of about 50 percent glycerol to about 20 percent methanol to about 30 percent water by weight. Example data point C corresponds to a preferred mixture with the ratios of about 44 percent glycerol to about 6 percent methanol to about 50 percent water by weight. Example data point D corresponds to a preferred mixture with the ratios of about 36 percent glycerol to about 14 percent methanol to about 50 percent water by weight.

Based on the location of example data point A on the graph in FIG. 3 it is predicted that a preferred mixture of about 58 percent glycerol to about 8 percent methanol to about 33 percent water by weight comprises a freezing point below about −50° C. (−58° F.), as it is below the freezing point curve 210 at −50° C. (−58° F.).

Based on the location of example data point B on the graph of FIG. 3, it is predicted that a preferred mixture of about 50 percent glycerol to about 20 percent methanol to about 30 percent water by weight will have a freezing point below about −50° C. (−58° F.), as it falls below the freezing point curve 210 at −50° C. (−58° F.).

Based on the location of example data point C on the graph of FIG. 3 it is predicted that a preferred mixture of about 44 percent glycerol to about 6 percent methanol to about 50 percent water by weight will have a freezing point below about −20° C. (−4° F.) and near about −30° C. (−22° F.), as the point falls below the freezing point curve 204 at −20° C. (−4° F.) and near the freezing point curve 206 at −30° C. (−22° F.).

Based on the location of example data point D on the graph of FIG. 3 it is predicted that a preferred mixture of about 36 percent glycerol to about 14 percent methanol to about 50 percent water by weight will comprise a freezing point below about −30° C. (−22° F.) as it falls below the freezing point curve 206 at −30° C. (−22° F.).

Applicant has created mixtures in these ranges which further included applicant's preferred corrosion inhibitor 577 (“GTC-580”), and found that the resulting mixtures show strong correlation with predictions based on FIG. 3.

Referring again to the flow chart of FIG. 1, glycerol engine-coolant system 100 comprises a preferred method 600 of producing applicant's preferred anti-freeze base material 310, which includes the following series of preferred steps. The first step of method 600 preferably involves identifying at least one biodiesel manufacturer 302 that manufactures the product biodiesel 304 using a transesterification process or other process yielding at least glycerol and preferably methanol (alternately preferably, ethanol) (crude glycerol 104). Upon reading this specification, those with ordinary skill in the art will now appreciate that, under appropriate circumstances, considering such issues as region of operation, manufacturer preferences, marketing preferences, cost, available materials, technological advances, etc., other material sources such as, for example, other industrial processes producing combinations of glycerol and short-chain alcohols, etc., may suffice.

Thereafter, the next preferred step is to identify a manner of disposal of waste by-products 306 from the biodiesel manufacturing process 301 of biodiesel manufacturer 302. In this preferred step, anti-freeze coolant manufacturer 308 determines acquisition logistics, assesses acquisition costs, and if viable, establishes an agreement with the biodiesel manufacturer arranging for the acquisition of the crude glycerol 104. Upon reading this specification, those with ordinary skill in the art will now appreciate that, under appropriate circumstances, considering such issues as biodiesel manufacturer preferences, cost, available products, technological advances, etc., other material arrangements, such as, for example, allowing the biodiesel manufacturer to recover some alcohol constituent, thus requiring the anti-freeze coolant manufacturer to further amend the crude glycerol with some additional methanol or other modifier, etc., may suffice.

The next preferred step preferably is to arrange for shipping the waste materials to a processing site operated by anti-freeze coolant manufacturer 308, as shown. In a subsequent preferred step of method 600, anti-freeze coolant manufacturer 308 produces applicant's preferred anti-freeze base material 310 by implementing at least one glycerol refinement process 350 to remove unwanted contaminates, for example, excess salts. In an optional preferred step, anti-freeze coolant manufacturer 308 further amends the base material to include one or more corrosion-inhibiting compounds, as shown. Such amendment step may preferably be carried out in response to customer requirements or in response to general demand within the marketplace. Upon reading this specification, those with ordinary skill in the art will now appreciate that, under appropriate circumstances, considering such issues as user preferences, manufacturer preferences, marketing preferences, cost, available materials, technological advances, etc., other processing steps, such as, for example, processes to produce specific ratios of glycerol, short-chain alcohols, water, etc., modifying the base material to include colorants, etc., may suffice.

Preferably, the glycerol-based anti-freeze coolant base material is then delivered to a product-assembly site 424 that is engaged in the assembly of products containing liquid-cooled components. Preferably, applicant's preferred anti-freeze base material 310 is held in a local base-material storage reservoir 412. Anti-freeze coolant base material 310 may be used as delivered or, more preferably, undergoes a preferred application-specific modification, as further described below.

FIG. 4 shows a diagrammatic representation of how anti-freeze coolant manufacturer 308 distributes anti-freeze base material 310 to a product-assembly site 424 and a preferred example of subsequent modification and use. In that regard, anti-freeze coolant base material is preferably transported to product-assembly site 424 by truck 410, alternately preferably by train, alternately preferably by pipeline. Representative product-assembly sites 424 preferably include vehicle assembly plants, industrial electrical generator manufacturers, heavy equipment manufacturers, etc. In each example, product-assembly site 424 operates at least one end-use requiring bulk quantities of anti-freeze base material 310.

As previously noted, anti-freeze coolant base material 310 is preferably stored in at least one bulk storage tank, or similar base-material storage reservoir, that is preferably located within or adjacent or abutting the end-use process. Upon reading this specification, those with ordinary skill in the art will now appreciate that, under appropriate circumstances, considering such issues as design preference, manufacturer preference, cost, changing needs, future technologies, etc., other types of liquid storage systems, such as, for example, bins, towers, tanks, hoppers, etc., may suffice.

Anti-freeze coolant base material 310 is preferably modified at product-assembly site 424. The glycerol-based anti-freeze coolant base material 310 is preferably modified by adding additional amounts of methanol and/or ethanol and/or water. Alternately preferably, anti-freeze coolant base material 310 is further preferably modified by adding selected amounts and/or preferably selected types of corrosion inhibitors. Product-assembly site 424 preferably comprises a supply of methanol 102 held in methanol storage tank 414, and a supply of water preferably stored in a water storage tank 416. Alternately preferably, water is supplied directly from a municipal water source, which may preferably be filtered or otherwise preconditioned.

A mixing system 500 is preferably used to combine materials from at least retained base-material storage reservoir 412, and methanol storage tank 414 and water storage tank 416 as desired for use to fill the cooling systems within products 420 undergoing assembly.

The on-site modification of anti-freeze coolant base material 310 preferably allows for the product manufacture to change the properties of the final anti-freeze coolant 107 as needed. It should be noted that the depicted system arrangements are preferably located inside product-assembly site 424; however, mixing system 500 can, alternately preferably, be located in a nearby facility operated by anti-freeze coolant manufacturer 308.

FIG. 5 shows a schematic diagram of a preferred mixing system 500 that is suitable for operation within product-assembly site 424 for preparing anti-freeze coolant 107 from anti-freeze base material 310. Mixing system 500 preferably provides a customer-suited anti-freeze coolant 107 preferably provided by modifying the glycerol based anti-freeze coolant base material 310 in accordance with the protection needs of a particular end-use application. Further, this preferred modification of properties of anti-freeze coolant base material 310 preferably can be done at the time and preferably the location of engine-coolant filling process.

Mixing system 500 preferably comprises a system of tanks, electronically controlled blenders, and instrumentation, which is preferably used to blend coolant components to prepare the custom anti-freeze coolant 107. Each storage tank preferably contains one of the above-noted components needed to amend anti-freeze coolant base material 310 to produce the final mixture. The storage tanks preferably include base-material storage reservoir 412, in this preferred example, an anti-freeze coolant base material storage tank 412, a methanol storage tank 414, and a corrosion inhibitor storage tank 520. Preferably, an additional tank could contain water; alternately preferably, water could be supplied as needed by preferably treating municipal water 516, preferably using a filtering system. Mixing system 500 preferably uses automation and control sensors to provide a means for supplying a continuous custom glycerol based anti-freeze coolant 107 to the assembly operations within product-assembly site 424.

Preferably, mixing system 500 can be programmed to deliver different mixtures at different times using automated valves 504 and controls. This preferably allows the single glycerol-based anti-freeze coolant base material 310 to generate anti-freeze coolant 107 comprising different properties to different types of engine applications.

Mixing system 500 preferably utilizes flow meters 506 and tank-volume sensors 508 to measure the quantity of material being used. Tank-volume sensors 508 are preferably radar based, alternately preferably servo based, alternately preferably comprise pressure differential level sensors. Radar-based units are preferably used due to their high accuracy and low maintenance. Furthermore, preferred embodiments of mixing system 500 implement monitoring of water percentage, specific gravity, and pH to ensure the proper additive content in the final coolant product. Preferred automated valves 504 comprise servo valves, alternately preferably electro valves that are preferably controlled by a Programmable Logic Controller (PLC 580). It is noted that the preferred monitoring of specific gravity, water content, etc., permits the quality of the blend to be certified for use by an engine manufacturer, thus satisfying warranty requirements of, for example, outside component suppliers. Upon reading this specification, those with ordinary skill in the art will now appreciate that, under appropriate circumstances, considering such issues as data type desired, design preference, manufacturer preference, cost, changing needs, future technologies, etc., other types of sensors and probes, such as, for example, turbidity sensors, viscosity testing meters, spectroscopic probes, etc., may suffice.

Thus, it is understood and enabled that onsite mixing of the onsite-ready anti-freeze coolant base with added ingredients provides a user-selected anti-freeze coolant composition. And thus, it is understood and enabled that such onsite mixing comprises the step of computer-assisting at least one control system to sense and control flows and mixtures to provide the user-selected anti-freeze coolant composition.

Other useful, if not vital, ingredients may preferably be added, preferably using the described control systems, to provide a user-selected anti-freeze coolant composition.

Applicant has developed a theory about how to best avoid or limit methanol toxicity in the event of accidental or other consumption of the discussed glycerin/water/methanol “waste” material and the resulting anti-freeze blend. In theory, if one combines glycerin with methanol, the blend will be toxic. According to applicant's theory, a solution to effectively cancel the toxicity of methanol used in an anti-freeze blend is to use ethanol in the blend; and this will reduce the effects of methanol if someone ingests the antifreeze blend. In considering applicant's proposed solution, applicant took into account years of examples in statistical studies about hospital emergency room procedures in treating methanol poisoning, including therapies attempted and conditions of the more successful therapies statistically.

According to applicant's theory, the preferred amounts of ethanol to be preferably added to applicant's antifreeze blend is from about 1% to about 5% of the antifreeze blend, by volume. It is noted that applicant's such preferred range may, for example, be compared to some recommended ethanol doses upon emergency room entry of cases of methanol poisoning, for example, about 100 milligrams per deciliter. A wider less-preferred range (than the 1%-5%) might correspond to emergency room prompt ethanol doses of from more than 0.01% to less than 20%, by volume.

Applicant notes, from applicant's studies of emergency-room medical procedures, that methanol and ethylene glycol poisonings, both clinically and biochemically, appear to share many characteristics. For example, both alcohols appear to be metabolised to their toxic metabolites through alcohol dehydrogenase. Methanol is slowly metabolised to formaldehyde, which is rapidly metabolised to formate, the metabolite whose accumulation appears to be mainly responsible for methanol toxicity.

Early treatment of both poisonings appears to be assisted by ethanol, which operates as an antimetabolite. Ethanol appears also to be metabolised by alcohol dehydrogenase and to have a much higher affinity for this enzyme than do methanol and/or ethylene glycol. So ethanol, if present, appears to inhibit formation of toxic metabolites from methanol and ethylene glycol. A preferred therapeutic ethanol concentration will depend upon on the concentration of alcohols. In a medical setting where there is typically insufficient trustable information, a therapeutic ethanol concentration of about 22 mmol/L (100 mg/dl) appears to be generally recommended.

Thus, applicant's system provides an alternate preferred low-toxicity anti-freeze coolant 107 having an ethanol 550 component, which is preferably added to the anti-freeze coolant base material 310 to reduce the ingested toxicity in the resulting anti-freeze coolant 107. Referring again to the production diagram of FIG. 4, ethanol 550 is preferably supplied to the base blend from ethanol storage tank 552. Preferably, ethanol 550 is added in concentrations between about 0.01% and about 20% by volume. In one preferred embodiment of the present system, a low-toxicity anti-freeze coolant 107 is produced by adding ethanol 550 in concentrations of between about 1% and 5% by volume. Another preferred low-toxicity anti-freeze coolant 107 comprises a ratio of ethanol 550 to methanol 102 of about 1:4 by volume. Preferably, such alternate low-toxicity anti-freeze coolants 107 are further amended to comprise ethylene glycol 590, in varying concentrations. Even further, preferred low-toxicity anti-freeze coolant compositions comprise one or more of the previously-described corrosion inhibitor(s) 577.

Applicant also provides a method of making a safer user-selected base; and referring again to the flow chart of FIG. 1, method 600 further comprises an additional series of preferred steps for producing a low-toxicity anti-freeze coolant composition.

In this regard, method 600 further comprises the preferred steps of adding an amount of ethanol 550 to reduce methanol-associated toxicity within the resulting user-selected anti-freeze coolant compositions. Preferably, the step of adding such ethanol component includes the step of amending the blend to comprise from about 0.01% and 20% ethanol 550 by volume. More preferably, the step of adding such ethanol component includes the step of amending the blend to comprise between about 1% to about 5% ethanol 550 by volume.

FIG. 6 shows a flow diagram depicting steps of a preferred method 700 of producing a low toxicity anti-freeze coolant base composition 707, in accordance with another preferred embodiment hereof. The preferred low toxicity anti-freeze coolant base composition 707 is preferably formulated to limit methanol toxicity in the event of accidental or other consumption of anti-freeze coolants containing applicant's base material. In that regard, the first preferred step 702 of method 700 preferably includes the specifying of at least one first non-ethanol composition 703 consisting at least of at least one non-ethanol user-selected alcohol. It is noted that such non-ethanol user-selected alcohols include, as preferred non-limiting examples, methanol, ethylene glycol, etc.

Next, as indicated in preferred step 704, at least one second composition 705 is specified that preferably consists of ethanol. Next, as indicated in preferred step 706, the relative amounts of the first non-ethanol composition 703, the second composition 705, and water are preferably controlled to provide at least one user-selected anti-freeze coolant base composition 707 to use in a specified cooling systems within at least one closed thermal control device, such as, for example, utilized within a vehicle product 420. Controlling the formulation can be implemented using, as a preferred example, the apparatus and processes of mixing system 500 (see FIG. 4).

In a preferred user-selected anti-freeze coolant base composition 707, the percentage by volume of ethanol to the at least one user-selected anti-freeze coolant base composition is between about 0.01% and about 20% of ethanol. More preferably, method 700 provides for the generation of at least one user-selected anti-freeze coolant base composition 707 having a percentage by volume of ethanol to the user-selected anti-freeze coolant base composition of between about 1% and 5% of ethanol. More preferably, method 700 provides for the generation of at least one user-selected anti-freeze coolant base composition 707 having percentage by volume of ethanol to the user-selected anti-freeze coolant base composition of about 2% of ethanol. Upon reading this specification, those with ordinary skill in the art will now appreciate that, under appropriate circumstances, considering such issues as intended use, user preferences, cost, thermal requirements, available materials, medical studies, technological advances, etc., other composition formulations, such as, for example, the implementation of higher or lower ratios of ethanol within the base composition, modulating the ethanol ratios in response to specific toxic-constituent volumes, etc., may suffice.

In an alternate preferred step of method 700, the preferred step 702 of specifying at least one first non-ethanol composition 703 further includes the preferred step of selecting at least one of the above-noted non-ethanol user-selected alcohol and/or at least one alcohol precursor having a property to become the at least one non-ethanol user-selected alcohol when mixed with water. Suitable alcohol precursors include alkenes and similar compounds derived from the dehydration of one or more non-ethanol alcohols.

In an alternate preferred step of method 700, the preferred step 702 of specifying such second composition 705 further includes the preferred step of selecting ethanol and/or at least one ethanol precursor having a property to become ethanol when mixed with water. Suitable alcohol precursors include alkenes and similar compounds derived from the dehydration of ethanol (for example, ethylene).

In the final preferred step 708, the resulting user-selected anti-freeze coolant base composition is added into the cooling systems of products 420, as diagrammatically illustrated.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1. An anti-freeze coolant base, retained from a co-product “waste material” from biodiesel manufacture, comprising:
a) retained glycerol from the waste material from biodiesel manufacture;
b) retained methanol from the waste material from biodiesel manufacture; and
c) retained water from the waste material from biodiesel manufacture;
d) wherein said anti-freeze coolant base contains no substantial amount of any retained waste material ingredients other than glycerol, methanol, and water.

2. The anti-freeze coolant base, according to claim 1, further comprising at least one effective corrosion inhibitor(s) in effective amounts for at least one projected use.

3. The anti-freeze coolant base according to claim 1 wherein the ratio (by weight) of retained glycerol to retained methanol is in the range of from about 2½ to 1 to about 7 to 1.

4. The anti-freeze coolant base, according to claim 3, further comprising at least one effective corrosion inhibitor(s) in effective amounts for at least one projected use.

5. The anti-freeze coolant base according to claim 3 further comprising an added amount of water not from retained waste material.

6. The anti-freeze coolant base, according to claim 5, further comprising at least one effective corrosion inhibitor(s) in effective amounts for at least one projected use.

7. The anti-freeze coolant base according to claim 1 further comprising an added amount of water not from retained waste material.

8. The anti-freeze coolant base, according to claim 7, further comprising at least one effective corrosion inhibitor(s) in effective amounts for at least one projected use.

9. The anti-freeze coolant base according to claim 1 further comprising an added amount of methanol not from retained waste material.

10. The anti-freeze coolant base, according to claim 9, further comprising at least one effective corrosion inhibitor(s) in effective amounts for at least one projected use.

11. An anti-freeze coolant base, retained from a co-product “waste material” from biodiesel manufacture, comprising:
a) retained glycerol from the waste material from biodiesel manufacture;
b) retained alcohol from the waste material from biodiesel manufacture; and
c) retained water from the waste material from biodiesel manufacture;
d) wherein said anti-freeze coolant base contains no substantial amount of any retained waste material ingredients other than glycerol, alcohol, and water.

12. The anti-freeze coolant base, according to claim 11, further comprising at least one effective corrosion inhibitor(s) in effective amounts for at least one projected use.

13. The anti-freeze coolant base according to claim 11 wherein the ratio (by weight) of retained glycerol to retained alcohol is in the range of from about 2½ to 1 to about 7 to 1.

14. The anti-freeze coolant base, according to claim 13, further comprising at least one effective corrosion inhibitor(s) in effective amounts for at least one projected use.

15. The anti-freeze coolant base according to claim 13 further comprising an added amount of water not from retained waste material.

16. The anti-freeze coolant base, according to claim 15, further comprising at least one effective corrosion inhibitor(s) in effective amounts for at least one projected use.

17. The anti-freeze coolant base according to claim 11 further comprising an added amount of water not from retained waste material.

18. The anti-freeze coolant base, according to claim 17, further comprising at least one effective corrosion inhibitor(s) in effective amounts for at least one projected use.

19. The anti-freeze coolant base according to claim 11 further comprising an added amount of alcohol not from retained waste material.

20. The anti-freeze coolant base, according to each of claim 19, further comprising at least one effective corrosion inhibitor(s) in effective amounts for at least one projected use.

21. A method of manufacture, of an anti-freeze coolant, comprising the steps of:
a) identifying a biodiesel manufacturer;
b) identifying a manner of disposal by the biodiesel manufacturer of a crude glycerol co-product “waste material” from biodiesel manufacture;
c) arranging to possess and move the waste material to an anti-freeze coolant manufacturer;
d) modifying the waste material to provide an anti-freeze coolant base comprising
i) retained glycerol from the waste material from biodiesel manufacture;
ii) retained alcohol from the waste material from biodiesel manufacture; and
iii) retained water from the waste material from biodiesel manufacture;
iv) wherein the anti-freeze coolant base contains no substantial amount of any retained waste material ingredients other than glycerol, alcohol, and water.

22. The method of manufacture, according to claim 21, wherein the alcohol comprises methanol.

23. The method of manufacture according to claim 21 wherein the step of modifying the waste material to provide an anti-freeze coolant base comprises the step of:
a) removing retained salts from the waste material from biodiesel manufacture;
b) wherein the anti-freeze coolant base becomes an onsite-ready anti-freeze coolant base.

24. The method of manufacture, according to claim 23, wherein the alcohol comprises methanol.

25. The method of manufacture according to claim 23 wherein the step of removing retained salts from the waste material from biodiesel manufacture comprises the step of:
a) at least one passing of the waste material through a user-selected membrane.

26. The method of manufacture, according to claim 25, wherein the alcohol comprises methanol.

27. The method of manufacture, according to claim 23, further comprising the step of:
a) onsite mixing of the onsite-ready anti-freeze coolant base with added ingredients to provide a user-selected anti-freeze coolant composition.

28. The method of manufacture, according to claim 27, wherein the alcohol comprises methanol.

29. The method of manufacture, according to claim 27, wherein such user-selected anti-freeze coolant composition comprises an added amount of ethanol.

30. The method of manufacture, according to claim 29, wherein such user-selected anti-freeze coolant composition comprises between about 0.01% and 20% ethanol by volume.

31. The method of manufacture, according to claim 30, wherein such user-selected anti-freeze coolant composition comprises from about 1% to about 5% ethanol by volume.

32. The method of manufacture, according to claim 27, wherein the step of onsite mixing comprises the step of computer-assisting at least one control system to sense and control flows and mixtures to provide the user-selected anti-freeze coolant composition.

33. The method of manufacture, according to claim 32, wherein the alcohol comprises methanol.

34. The method of manufacture, according to claim 31, wherein such user-selected anti-freeze coolant composition comprises an added amount of ethanol.

35. The method of manufacture, according to claim 34, wherein such user-selected anti-freeze coolant composition comprises between about 0.01% and 20% ethanol by volume.

36. The method of manufacture, according to claim 35, wherein such user-selected anti-freeze coolant composition comprises from about 1% to about 5% ethanol by volume.

37. A low-toxicity anti-freeze coolant composition, having at least one component retained from a co-product “waste material” of biodiesel manufacture, said low-toxicity anti-freeze coolant composition comprising:
a) retained glycerol from the waste material from biodiesel manufacture;
b) retained methanol from the waste material from biodiesel manufacture;
c) retained water from the waste material from biodiesel manufacture; and
d) ethanol;
e) wherein the amount of such ethanol is between about 0.01% and about 20% by volume.

38. The low-toxicity anti-freeze coolant composition, according to claim 37, further comprising at least one effective corrosion inhibitor(s) in effective amounts for at least one projected use.

39. The low-toxicity anti-freeze coolant composition according to claim 37 wherein the amount of such ethanol is between about 1% and 5% ethanol by volume.

40. The low-toxicity anti-freeze coolant composition, according to claim 39, further comprising at least one effective corrosion inhibitor(s) in effective amounts for at least one projected use.

41. The low-toxicity anti-freeze coolant composition according to claim 37 wherein the ratio of such ethanol to such retained methanol is about 1:4 by volume.

42. The low-toxicity anti-freeze coolant composition, according to claim 41, further comprising at least one effective corrosion inhibitor(s) in effective amounts for at least one projected use.

43. The low-toxicity anti-freeze coolant composition according to claim 37 further comprising ethylene glycol.

44. The low-toxicity anti-freeze coolant composition, according to claim 43, further comprising at least one effective corrosion inhibitor(s) in effective amounts for at least one projected use.

45. A method of making a low toxicity anti-freeze coolant base composition, said method comprising the steps of:
a) specifying at least one first non-ethanol composition consisting of at least one non-ethanol user-selected alcohol;
b) specifying at least one second composition consisting of ethanol;
c) controlling the relative amounts of the at least one first non-ethanol composition, the at least one second composition, and water to provide at least one user-selected anti-freeze coolant base composition to use in a specified closed thermal control device; and
d) adding the at least one user-selected anti-freeze coolant base composition into the specified closed thermal control device;
e) wherein the percentage by volume, in the at least one user-selected anti-freeze coolant base composition, of ethanol to the at least one user-selected anti-freeze coolant base composition is between about 0.01% and about 20% of ethanol.

46. The method of claim 45 wherein the percentage by volume, in the at least one user-selected anti-freeze coolant base composition, of ethanol to the at least one user-selected anti-freeze coolant base composition is between about 1% and 5% of ethanol.

47. The method of claim 46 wherein the percentage by volume, in the at least one user-selected anti-freeze coolant base composition, of ethanol to the at least one user-selected anti-freeze coolant base composition is about 2% of ethanol.

48. The method of claim 45 wherein:
a) the step of specifying such at least one first non-ethanol composition includes the selection from the group consisting of
i) such at least one non-ethanol user-selected alcohol, and
ii) at least one alcohol precursor having a property to become the at least one non-ethanol user-selected alcohol when mixed with water; and
b) the step of specifying such at least one second composition includes the selection from the group consisting of
i) ethanol, and
ii) at least one ethanol precursor having a property to become ethanol when mixed with water.
